(19) United States
(12) Patent Application Publication
(10) Pub. No.: US 2021/0073356 A1
(43) Pub. Date: Mar. 11, 2021

(54) INFORMATION PROCESSING SYSTEM, INFORMATION PROCESSING METHOD, AND STORAGE MEDIUM FOR STORING INFORMATION PROCESSING PROGRAM

(71) Applicant: SHARP KABUSHIKI KAISHA, Sakai City (JP)

(72) Inventors: KEIKO HIRUKAWA, Sakai City (JP); YUUKI IWAMOTO, Sakai City (JP); SATOSHI TERADA, Sakai City (JP)

(21) Appl. No.: 17/008,093

(22) Filed: Aug. 31, 2020

(30) Foreign Application Priority Data
Sep. 10, 2019 (JP) 2019-164219

(51) Int. Cl. G06F 21/12; G06Q 10/10

(52) U.S. Cl. CPC G06F 21/125; G06Q 2220/18; G06Q 10/1095

(57) ABSTRACT

An information processing system according to the present disclosure includes a registration processor that registers, in a storage, location information indicating a location where a meeting is held, identification information of a device installed at the location where the meeting is held, and license information regarding a license for a function corresponding to the device, in a mutually associated manner, an inquiry acquirer that acquires an inquiry whether the license for the function is present, and a utilization controller that controls a utilization of the function, based on the location information, the identification information of the device, and the license information stored in the storage, if the inquiry is acquired by the inquiry acquirer.

### INCORPORATION BY REFERENCE

This application is based upon and claims the benefit of priority from the corresponding Japanese Patent Application No. 2019-164219 filed on Sep. 10, 2019, the entire contents of which are incorporated herein by reference.

### BACKGROUND OF THE INVENTION

### Field of the Invention

The present disclosure relates to an information processing system, an information processing method, and a storage medium for storing an information processing program.

### Description of the Background Art

Conventionally, there has been proposed a license count management apparatus that enables a predetermined program to be executed between devices within a fixed number of licenses. For example, the license count management apparatus is an MFP having an application manager that acquires an application saved in a USB memory and the license information thereof, the license count management apparatus including an extractor for extracting the number of licenses from the license information, an extractor for extracting program enabled/disabled data for each MFP from all MFPs belonging to a predetermined group, a calculator for calculating a remaining number of licenses of a program in a group based on the enabled/disabled data and the number of licenses, a permitter for enabling and permitting the execution of a self-acquired program within a range of a remaining number of licenses, a sender for sending a disabling code to another device, and a limiter for disabling and limiting the execution of a self-acquired program in response to the receipt of a disabling code.

Among the applications, there may be an application the utilization of which by the user is permitted only at a specific location. For example, if a meeting is held in a predetermined meeting room, the participants of the meeting can utilize the predetermined application only in the meeting room. In such a case, it is desirable that a license for the application is granted to each meeting room. However, according to the conventional technology, a license is granted to each device, and therefore, in the above case, it is necessary to enable the license for each device when the meeting is started, because of which the meeting cannot be efficiently held.

### SUMMARY

An object of the present disclosure is to provide an information processing system, an information processing method, and a storage medium for storing an information processing program capable of efficiently holding a meeting by managing an application license for each meeting room.

An information processing system according to an aspect of the present disclosure includes a registration processor that registers, in a storage, location information indicating a location where a meeting is held, identification information of a device installed at the location where the meeting is held, and license information regarding a license for a function corresponding to the device, in a mutually associated manner, an inquiry acquirer that acquires an inquiry whether the license for the function is present, and a utilization controller that controls a utilization of the function, based on the location information, the identification information of the device, and the license information stored in the storage, if the inquiry is acquired by the inquiry acquirer.

An information processing method according to another aspect of the present disclosure includes using one or more processing devices to execute registering, in a storage, location information indicating a location where a meeting is held, identification information of a device installed at the location where the meeting is held, and license information regarding a license for a function corresponding to the device, in a mutually associated manner; acquiring an inquiry whether the license for the function is present; and controlling a utilization of the function, based on the location information, the identification information of the device, and the license information stored in the storage, if the inquiry is acquired.

A non-transitory storage medium according to another aspect of the present disclosure is a non-transitory storage medium for storing an information processing program for causing one or more processing devices to execute registering, in a storage, location information indicating a location where a meeting is held, identification information of a device installed at the location where the meeting is held, and license information regarding a license for a function corresponding to the device, in a mutually associated manner; acquiring an inquiry whether the license for the function is present; and controlling a utilization of the function, based on the location information, the identification information of the device, and the license information stored in the storage, if the inquiry is acquired.

The present disclosure provides an information processing system, an information processing method, and a non-transitory storage medium for storing an information processing program capable of efficiently holding a meeting by managing an application license for each meeting room.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic diagram illustrating a simplified configuration of a meeting system according to an embodiment of the present disclosure;

FIG. 2 is a functional block diagram illustrating a configuration of the meeting system according to the embodiment of the present disclosure;

FIG. 3 is a diagram illustrating an example of meeting room information utilized in the meeting system according to the embodiment of the present disclosure;

FIG. 4 is a diagram illustrating an example of device information utilized in the meeting system according to the embodiment of the present disclosure;

FIG. 5 is a diagram illustrating an example of user information utilized in the meeting system according to the embodiment of the present disclosure;

FIG. 6 is a diagram illustrating an example of meeting information utilized in the meeting system according to the embodiment of the present disclosure;

FIG. 7 is a diagram illustrating an example of license information utilized in the meeting system according to the embodiment of the present disclosure;

FIG. 8 is a diagram illustrating an example of meeting room terminal information utilized in the meeting system according to the embodiment of the present disclosure;

FIG. 9 is a flowchart for explaining an example of a procedure of a meeting support process executed in the meeting system according to the embodiment of the present disclosure; and

FIG. 10 is a flowchart for explaining an example of a procedure of a meeting support process executed in the meeting system according to the embodiment of the present disclosure.

### DETAILED DESCRIPTION

An embodiment of the present disclosure will be described below with reference to the attached drawings. The following embodiment is an example in which the present disclosure is embodied, and does not intend to limit the technical scope of the present disclosure.

The information processing system according to the present disclosure can be applied to, for example, a meeting in which one or more users participate in one location (a meeting room). The meeting system according to the present embodiment is an example of the information processing system according to the present disclosure. For example, in the meeting system according to the present embodiment, a meeting room terminal (user terminal) utilized by each user participating in a meeting, and devices (meeting devices) such as a display device that displays a display screen of the meeting room terminal etc., a sharing device for sharing the display screen of each meeting room terminal, and a voice processing device that receives the voice of a user are arranged in the meeting room. The meeting system includes a management server that manages licenses of applications available in the meeting room.

### Meeting System 100

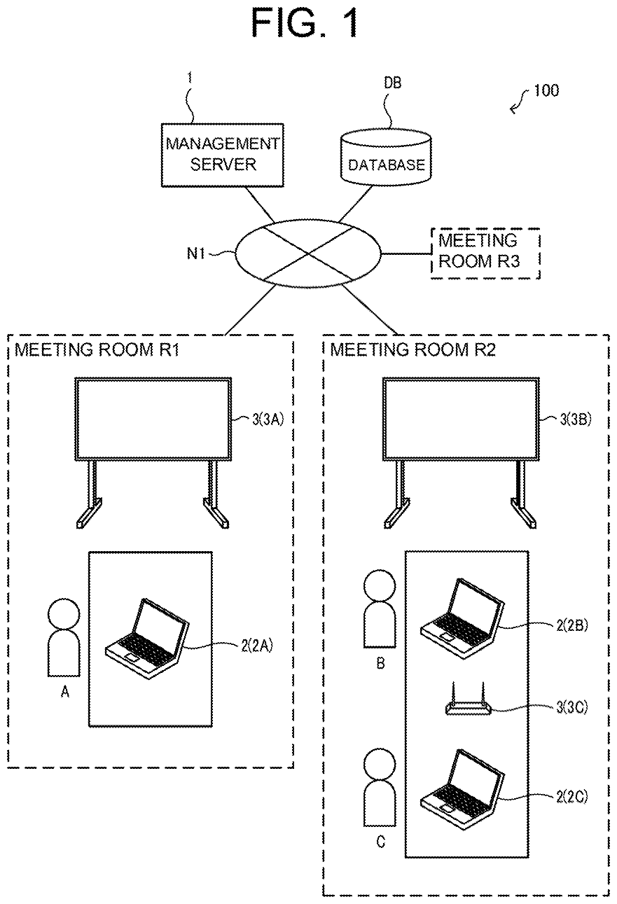

FIG. 1 is a diagram illustrating a simplified configuration of a meeting system according to an embodiment of the present disclosure. The meeting system 100 includes a management server 1, a meeting room terminal 2, a meeting device 3, and a database DB. FIG. 1 illustrates a meeting room R1 and a meeting room R2. In the meeting room R1, a meeting room terminal 2A utilized by a user A being a participant of a meeting, and a display device 3A being an example of the meeting device 3 are arranged. In the meeting room R2, a meeting room terminal 2B utilized by a user B and a meeting room terminal 2C utilized by a user C being participants of a meeting, and a display device 3B and a sharing device 3C being an example of the meeting device 3 are arranged.

The management server 1 is composed of, for example, one or more data servers (virtual servers). The database DB stores various types of data. The database DB may be included in any one of the management server 1, the meeting room terminal 2, and the meeting device 3, or may be dispersedly included in a plurality of devices. The meeting room terminal 2 may be a terminal device of a user him/herself that the user participating in the meeting carries to the meeting room. The meeting room may include, for example, as many meeting room terminals 2 as the number of users participating in the meeting.

The management server 1, the meeting room terminal 2, the meeting device 3, and the database DB are connected to each other via a network N1. The network N1 is a communication network such as the Internet, LAN, WAN, or public telephone line. The meeting device 3 is an example of the devices according to the present disclosure. The meeting room terminal 2 is an example of an operation terminal according to the present disclosure.

### Management Server 1

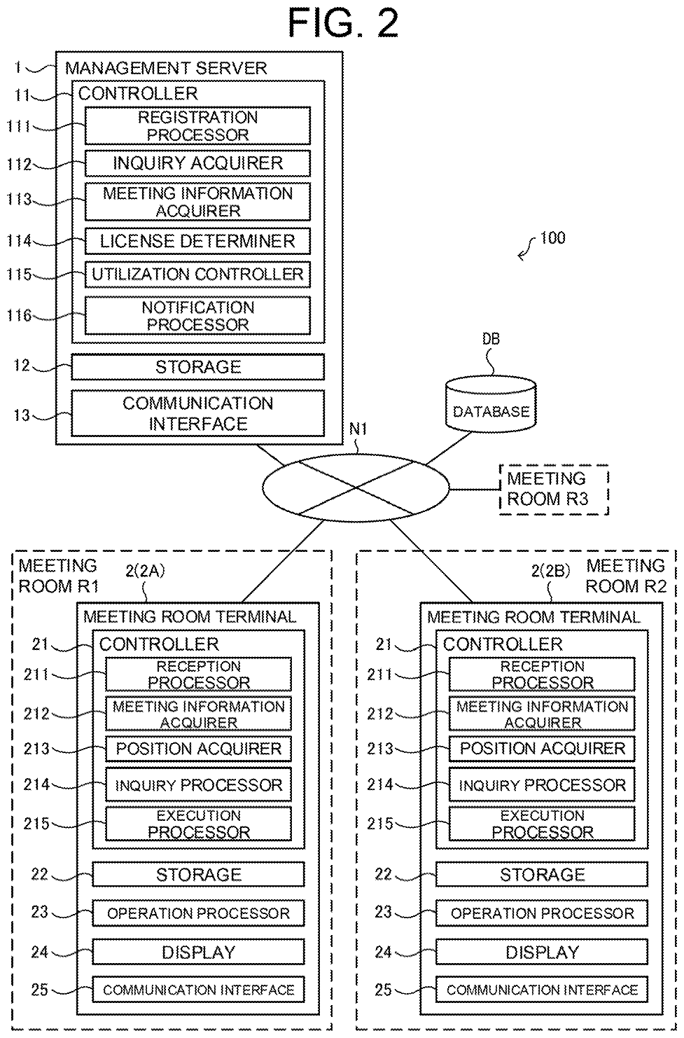

As illustrated in FIG. 2, the management server 1 includes a controller 11, a storage 12, a communication interface 13, and the like. The management server 1 may be one or more virtual servers (cloud servers) or one or more physical servers.

The communication interface 13 connects the management server 1 to the network N1 by wire or wirelessly, and is a communication interface for performing data communication following a predetermined communication protocol, with other devices (for example, the meeting room terminal 2, the meeting device 3, and the database DB) via the network N1.

The storage 12 is a non-volatile storage such as a flash memory that stores various types of information. The storage 12 stores a control program such as a meeting support processing program or the like for causing the controller 11 to execute a meeting support process described later. For example, the meeting support processing program may be recorded non-temporarily in a computer-readable recording medium such as a CD or a DVD, read by a reading device (not illustrated) such as a CD drive or a DVD drive provided in the management server 1, and stored in the storage 12.

The controller 11 includes a control device such as a CPU, a ROM, and a RAM. The CPU is a processing device for executing various types of arithmetic processes. The ROM stores in advance a control program such as BIOS and OS for causing the CPU to execute various types of processes. The RAM stores various information and is used as a temporary storage memory (working area) for various processes to be executed by the CPU. The controller 11 controls the management server 1 by causing the CPU to execute various types of control programs stored in advance in the ROM or the storage 12.

The controller 11 executes various types of processes with reference to the database DB. The database DB stores data such as meeting room information D1, device information D2, user information D3, meeting information D4, license information D5, meeting room terminal information D6, and the like.

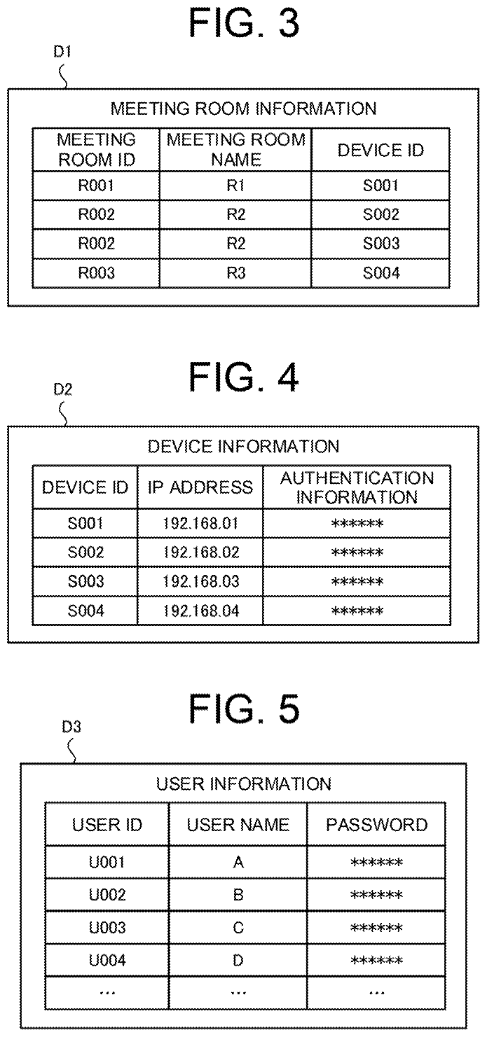

FIG. 3 illustrates an example of the meeting room information D1. In the meeting room information D1, information such as a “meeting room ID”, a “meeting room name”, and a “device ID” corresponding to each meeting room is registered in a mutually associated manner. The “meeting room ID” is identification information of the meeting room, and the “meeting room name” is the name of the meeting room. The “device ID” is identification information of the meeting device 3 installed in the meeting room. For example, if the display device 3A is installed in the meeting room R1, the identification information “S001” of the display device 3A is registered in the device ID corresponding to the meeting room R1. Similarly, if the sharing device 3C and the display device 3B are installed in the meeting room R2, the identification information “S002” of the sharing device 3C and the identification information “S003” of the display device 3B are registered in the device ID corresponding to the meeting room R2.

FIG. 4 illustrates an example of the device information D2. In the device information D2, information such as a “device ID”, an “IP address”, and “authentication information” corresponding to each meeting device 3 is registered in a mutually associated manner. The “device ID” is identification information of the meeting device 3 installed in the meeting room, and is the same as the “device ID” of the meeting room information D1. The “authentication information” is information for authenticating the meeting device 3, and includes a port number, a password, a PIN number, and the like. Further, in the device information D2, access information (authentication information or the like) for accessing a cloud storage (described later) connected to the network N1 is registered. The cloud storage stores, for example, a file (display data) uploaded by the user.

FIG. 5 illustrates an example of the user information D3. In the user information D3, information such as a “user ID”, a “user name”, and a “password” corresponding to each user is registered in a mutually associated manner. In the user information D3, information about not only the users participating in the meeting but all users who have the authority to utilize the meeting system 100 is registered in advance. For example, the information of all employees of a company is registered in the user information D3. The “user ID” is identification information of the user, and the “user name” is the name of the user. The “user ID” and “password” are information utilized for login when the user participates in the meeting.

For example, a user participating in a meeting launches a meeting support application (described later) in his/her own meeting room terminal 2 upon starting the meeting, and inputs the user ID and the password being the login information on a login screen. The management server 1 performs a login process based on the login information. If the license for the meeting support application is granted to the meeting room where the meeting is held, the logged-in user is able to participate in the meeting utilizing the meeting support application.

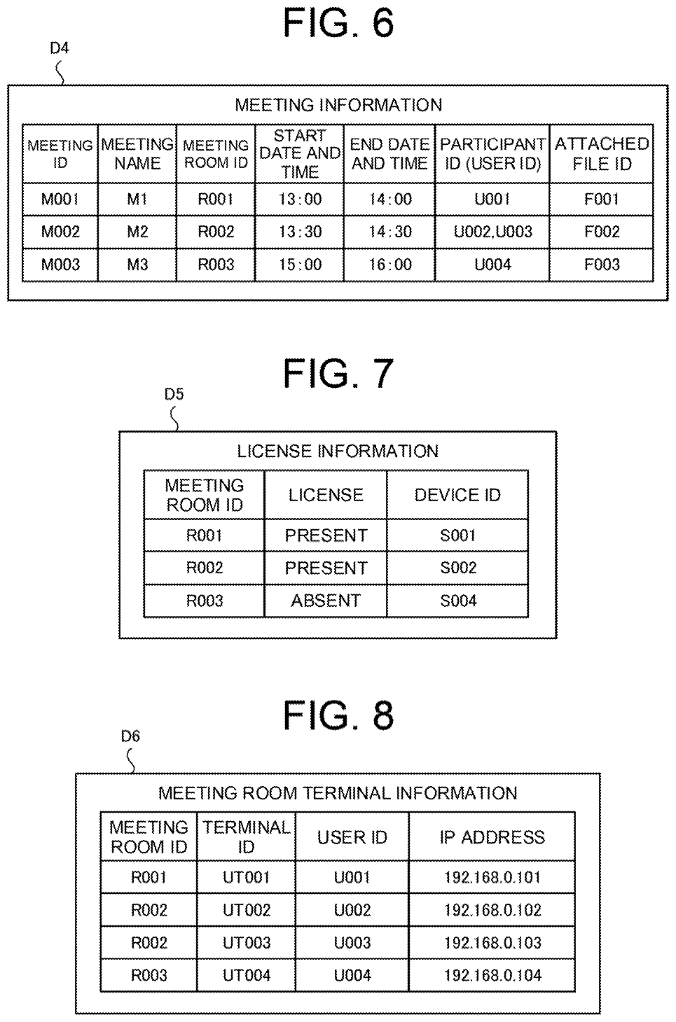

FIG. 6 illustrates an example of the meeting information D4. In the meeting information D4, information (schedule information) such as a “meeting ID”, a “meeting name”, a “meeting room ID”, a “start date and time”, an “end date and time”, a “participant ID”, and an “attached file ID” corresponding to each meeting is registered in a mutually associated manner. The “meeting ID” is identification information of the meeting, and the “meeting name” is the name (subject name) of the meeting. The “start date and time” is the date and time of start of the meeting, and the “end date and time” is the date and time of end of the meeting. The “participant ID” is identification information (user ID) of a user participating in the meeting. The “attached file ID” is identification information of a file (material) used in the meeting, and the file data corresponding to the attached file ID is stored in the database DB. The meeting information D4 is registered in advance by a person in charge or the like, when the schedule of the meeting is decided. FIG. 6 illustrates that the user A (“U001”) is registered as a participant of a meeting M1 held in the meeting room R1 (“R001”), the user B (“U002”) and the user C (“U003”) are registered as participants of a meeting M2 held in the meeting room R2 (“R002”), and the user C (“U003”) is registered as a participant of a meeting M3 held in the meeting room R3 (“R003”).

FIG. 7 illustrates an example of the license information D5. In the license information D5, information such as a “license” and a “device ID” is registered in a mutually associated manner for each location (meeting room) where the meeting is held. The “license” is information indicating whether a license for a predetermined application is present.

Here, the predetermined application is, for example, an application that supports a meeting, such as an application for controlling the display device 3A by a process for displaying the display screen of the meeting room terminal 2 on the display device 3A installed in the meeting room R1, a process for turning ON or OFF the power of the display device 3A by voice, a process for changing the volume of the display device 3A by voice, or the like; an application for sharing the display screen from the meeting room terminal 2B arranged in the meeting room R2 to the display device 3B and the meeting room terminal 2C by controlling the sharing device 3C installed in the meeting room R2; an application for executing a voice command by controlling the voice processing device 3D installed in the meeting room R3; and an application for accessing a storage (for example, the database DB) that stores an attached file (the display data) to be displayed on the display device 3A installed in the meeting room R1. Hereinafter, the predetermined application will be referred to as a “meeting support application”. Each of the display device 3A, the sharing device 3C, and the voice processing device 3D is an example of the device according to the present disclosure.

The “device ID” illustrated in FIG. 7 is identification information of the meeting device 3 that executes the meeting support application. For example, the meeting room R1 having the meeting room ID “R001” is granted a license for the meeting support application capable of controlling the display device 3A “S001” by voice. The meeting room R2 having the meeting room ID “R002” is granted a license for the meeting support application capable of controlling the sharing device 3C “S002” for sharing the display screen of the meeting room terminal 2B and the display screen of the meeting room terminal 2C. It is noted that the meeting room R3 having the meeting room ID “R003” is not granted a license for the meeting support application capable of controlling the voice processing device 3D “S004” that can receive the voice of the user.

FIG. 8 illustrates an example of the meeting room terminal information D6. In the meeting room terminal information D6, information on the meeting room terminal 2 utilized by the user who has logged in upon the start of the meeting is registered. In the meeting room terminal information D6, information such as the “meeting room ID”, the “terminal ID”, the “user ID”, and the “IP address” is registered in a mutually associated manner. The “terminal ID” is identification information of the meeting room terminal 2, and the “user ID” is identification information of a user utilizing the meeting room terminal 2. If the user inputs the login information, the identification information of the meeting room terminal 2 of the user is registered in the “terminal ID”. In the meeting room terminal information D6, information on the meeting room terminal 2 utilized by the users participating in the meeting is registered and updated in real time.

A part or all of the information such as the meeting room information D1, the device information D2, the user information D3, the meeting information D4, the license information D5, and the meeting room terminal information D6 may be stored in any one of the management server 1, the meeting room terminal 2, and the meeting device 3, or may be dispersedly stored in a plurality of the devices. Each information may be stored in a server accessible from the meeting system 100. In this case, the meeting system 100 may acquire each information from the server and execute each process such as the meeting support process or the like described later.

As illustrated in FIG. 2, the controller 11 includes various processors such as a registration processor 111, an inquiry acquirer 112, a meeting information acquirer 113, a license determiner 114, a utilization controller 115, and a notification processor 116. The controller 11 functions as the various types of processors by causing the CPU to execute various types of processes according to the control programs. Some or all of the processors included in the controller 11 may be implemented by an electronic circuit. The control programs may be programs for causing a plurality of processing devices to function as the various types of processors.

The registration processor 111 registers, in the database DB, the location information (meeting room ID) indicating a location (meeting room) where the meeting is held, the identification information (device ID) of the meeting device 3 installed in the meeting room, and the license information regarding the license for the function corresponding to the meeting device 3 (the meeting support application) in a mutually associated manner. The registration processor 111 is an example of a registration processor according to the present disclosure. Specifically, the registration processor 111 registers, in the meeting room information D1 (see FIG. 3), the meeting room ID and the identification information (device ID) of the meeting device 3 installed in the meeting room in a mutually associated manner, for each meeting room. For example, if the display device 3A is connected to the network N1 and acquires the IP address and the authentication information (see FIG. 4), the registration processor 111 registers, in the meeting room information D1, the meeting room ID “R001” and the device ID “S001” of the display device 3A.

Further, the registration processor 111 registers, in the meeting room terminal information D6 (see FIG. 8), the meeting room ID, the user ID of the user who has logged in upon the start of the meeting, and the identification information (terminal ID) of the meeting room terminal 2 utilized by the user in a mutually associated manner.

Further, the registration processor 111 registers, in the license information D5 (see FIG. 7), the meeting room ID and information on whether a license for the meeting support application is present, in a mutually associated manner, for each meeting room. For example, the registration processor 111 registers, in the license information D5 (see FIG. 7), the meeting room ID “R001” of the meeting room R1, the device ID “S001” of the display device 3A installed in the meeting room R1, and the license information “Present” of the meeting support application in a mutually associated manner. Further, the registration processor 111 registers, in the license information D5 (see FIG. 7), the meeting room ID “R002” of the meeting room R2, the device ID “S002” of the sharing device 3C installed in the meeting room R2, and the license information “Present” of the meeting support application in a mutually associated manner. Also, the registration processor 111 registers, in the license information D5 (see FIG. 7), the meeting room ID “R003” of the meeting room R3, the device ID “S004” of the voice processing device 3D installed in the meeting room R3, and the license information “Absent” of the meeting support application in a mutually associated manner. The registration processor 111 registers the license information D5 in advance before the meeting starts.

The inquiry acquirer 112 acquires an inquiry whether a license for the meeting support application is present, from the meeting room terminal 2. The inquiry acquirer 112 is an example of the inquiry acquirer according to the present disclosure. For example, if the user A activates the meeting support application in the meeting room terminal 2 of the meeting room R1, the meeting room terminal 2A sends an inquiry for checking whether a license for the utilization of the meeting support application in the meeting room R1 is present (a utilization permission or denial). The inquiry includes meeting room information (the meeting room ID), user information (a participant ID, an email address, or the like), a meeting system type (system ID), position information of the meeting room terminal 2, and the like. The inquiry acquirer 112 acquires the inquiry including each information from the meeting room terminal 2A.

The meeting information acquirer 113 acquires the meeting information from the meeting information D4. Specifically, the meeting information acquirer 113 acquires the meeting information corresponding to each information included in the inquiry with reference to the meeting information D4 (see FIG. 6).

The license determiner 114 determines whether the license for the meeting support application is present, based on the meeting information acquired by the meeting information acquirer 113, and each information about the inquiry acquired by the inquiry acquirer 112. The license determiner is an example of the license determiner according to the present disclosure. For example, if the meeting information acquirer 113 acquires the inquiry from the meeting room terminal 2A, the license determiner 114 determines whether a license corresponding to the meeting room ID “R001” and the device ID “S001” of the display device 3A is present, with reference to the license information D5 (see FIG. 7). The license determiner 114 determines that the license for the meeting support application is present if a license for the meeting support application is granted to the meeting device 3 installed in the meeting room. In this case, a license for the meeting support application is granted to the display device 3A “S001” installed in the meeting room R1 where the meeting M1 is held, and therefore, the license determiner 114 determines that the license for the meeting support application in the display device 3A corresponding to the meeting room R1 is “Present”.

If the license for the meeting support application is granted to the meeting room R1, and if the position of the meeting room terminal 2 is included in the meeting room, the license determiner 114 may determine that the license is “Present”. For example, the meeting room terminal 2 acquires the position information of the meeting room terminal 2 itself by utilizing a communication function, and sends the inquiry including the acquired position information, to the management server 1 (described later). Upon acquiring the position information from the meeting room terminal 2, the license determiner 114 determines that the license is “Present” if the meeting room terminal 2 exists in the meeting room to which the license is granted. The license determiner 114 can determine whether the meeting room terminal 2 is positioned in a predetermined meeting room using a known method.

If the license for the meeting support application is granted to the meeting room R1, and further, if the identification information (the participant ID) of the user utilizing the meeting device 3 matches the participant ID registered in the meeting information D4 (see FIG. 6), the license determiner 114 may determine that the license is “Present”.

If the license for the meeting support application is granted to the meeting room R1, and further, if the system ID matches the system ID of the meeting system available in the meeting system 100, the license determiner 114 may determine that the license is “Present”.

If the inquiry is acquired by the inquiry acquirer 112, the utilization controller 115 controls the utilization of the meeting support application, based on the meeting room ID, the identification information of the meeting device 3, and the license information. The utilization controller 115 is an example of a utilization controller according to the present disclosure. Specifically, the utilization controller 115 permits or prohibits the utilization of the meeting support application according to the determination result by the license determiner 114.

For example, if it is determined by the license determiner 114 that the license for the meeting support application is “Present” for the display device 3A corresponding to the meeting room R1, the utilization controller 115 permits the display device 3A installed in the meeting room R1 to utilize the meeting support application, and sets the meeting support application to enabled.

Also, for example, if it is determined by the license determiner 114 that the license for the meeting support application is “Present” for the sharing device 3C corresponding to the meeting room R2, the utilization controller 115 permits the sharing device 3C installed in the meeting room R2 to utilize the meeting support application, and sets the meeting support application to enabled.

On the other hand, if for example, it is determined by the license determiner 114 that the license for the meeting support application is “Absent” for the voice processing device 3D corresponding to the meeting room R3, the utilization controller 115 prohibits the voice processing device 3D installed in the meeting room R3 from utilizing the meeting support application, and sets the meeting support application to disabled.

A processor corresponding to the utilization controller 115 may be included in the controller 21 of the meeting room terminal 2. That is, the controller 21 of the meeting room terminal 2 may execute the process for controlling the utilization of the meeting support application, based on the meeting room ID, the identification information of the meeting device 3, and the license information.

If the inquiry is acquired by the inquiry acquirer 112, the notification processor 116 notifies the meeting room terminal 2 of the determination result (response) about presence or absence of the license by the license determiner 114. For example, the notification processor 116 notifies the meeting room terminal 2A of a response (“License present”) indicating that the license for the meeting support application is present for the display device 3A. For example, the notification processor 116 notifies the meeting room terminals 2B and 2C of a response (“License present”) indicating that the license for the meeting support application is present for the sharing device 3C. For example, the notification processor 116 notifies the meeting room terminal 2D of a response (“License absent”) indicating that the license for the meeting support application is not present for the voice processing device 3D.

### Meeting Room Terminal 2

As illustrated in FIG. 2, the meeting room terminal 2 includes a controller 21, a storage 22, an operation processor 23, a display 24, a communication interface 25, and the like. FIG. 2 illustrates the meeting room terminal 2A arranged in the meeting room R1, and the meeting room terminal 2B arranged in the meeting room R2. The meeting room terminals 2A and 2B have the same function.

The operation processor 23 is a mouse, a keyboard, a touch panel, or the like that receives an operation of a user utilizing the meeting room terminal 2. The display 24 is a display panel such as a liquid crystal display or an organic EL display that displays various types of information. The operation processor 23 and the display 24 may be an integrally formed user interface.

The communication interface 25 connects the meeting room terminal 2 to the network N1 by wire or wirelessly, and is a communication interface for performing data communication following a predetermined communication protocol, with other devices (for example, the management server 1, the meeting device 3, and the database DB) via the network N1.

The storage 22 is a non-volatile storage such as a flash memory that stores various types of information. The storage 22 stores a control program such as a meeting support processing program or the like for causing the controller 21 to execute a meeting support process described later. For example, the meeting support processing program may be recorded non-temporarily in a computer-readable recording medium such as a CD or a DVD, read by a reading device (not illustrated) such as a CD drive or a DVD drive provided in the meeting room terminal 2, and stored in the storage 22.

The controller 21 includes control devices such as a CPU, a ROM, and a RAM. The CPU is a processing device for executing various types of arithmetic processes. The ROM stores in advance a control program such as BIOS and OS for causing the CPU to execute various types of processes. The RAM stores various information and is used as a temporary storage memory (working area) for various processes to be executed by the CPU. The controller 21 controls the meeting room terminal 2 by causing the CPU to execute various types of control programs stored in advance in the ROM or the storage 22.

Specifically, the controller 21 includes various processors such as a reception processor 211, a meeting information acquirer 212, a position acquirer 213, an inquiry processor 214, and an execution processor 215. The controller 21 functions as the various types of processors by causing the CPU to execute various types of processes according to the control programs. Some or all of the processors included in the controller 21 may be implemented by an electronic circuit. The control programs may be programs for causing a plurality of processing devices to function as the various types of processors.

The reception processor 211 receives various operations from the user. For example, the reception processor 211 receives an operation for launching the meeting support application from the user. For example, if the user A performs an operation to launch the meeting support application in the meeting room terminal 2A upon the start of meeting M1 in the meeting room R1, the reception processor 211 receives the operation. When the user A performs an operation of entering the user ID and the password on the login screen of the meeting support application, the reception processor 211 acquires the user ID and the password. Once the reception processor 211 acquires the user ID and the password, the management server 1 performs the login process based on the login information.

The meeting information acquirer 212 acquires the meeting information from the database DB. Specifically, the meeting information acquirer 212 acquires the meeting information corresponding to the user ID of the logged-in user, from the meeting information D4 (see FIG. 6). For example, if the user A “U001” logs in at the meeting room terminal 2A, the meeting information acquirer 212 of the meeting room terminal 2A acquires the meeting information corresponding to the user ID “U001” with reference to the meeting information D4 of the database DB.

The meeting information acquirer 212 may acquire the meeting information corresponding to the meeting room ID of the meeting room in which the meeting room terminal 2 is arranged. For example, the meeting information acquirer 212 of the meeting room terminal 2A acquires the meeting room ID “R001” when the meeting room terminal 2A is arranged in the meeting room R1 and is connected to the network N1. The meeting information acquirer 212 of the meeting room terminal 2A acquires the meeting information corresponding to the acquired meeting room ID “R001” with reference to the meeting information D4 of the database DB.

The position acquirer 213 acquires the position information of the meeting room terminal 2. The position acquirer 213 can acquire the position information using a known method. For example, the position acquirer 213 acquires the position information by utilizing a communication function installed in the meeting room terminal 2, a beacon installed in the meeting room, a short-range wireless communication device, or the like. The position acquirer 213 may be omitted in the meeting room terminal 2.

The inquiry processor 214 sends the inquiry whether a license for the meeting support application is present, to the management server 1. The inquiry includes meeting room information (the meeting room ID), user information (a participant ID, an email address, or the like), a meeting system type (system ID), and the like. If the meeting room terminal 2 includes the position acquirer 213, the inquiry further includes the position information.

The execution processor 215 executes the meeting support application. The execution processor 215 is an example of an execution processor according to the present disclosure. Specifically, if the meeting support application is set to enabled by the utilization controller 115 and a “License present” response for the meeting support application is acquired from the notification processor 116, the execution processor 215 executes the meeting support application. For example, if the meeting support application is set to enabled for the meeting device 3 (the display device 3A, the sharing device 3C, the voice processing device 3D, and the like) by the utilization controller 115, the execution processor 215 connects the meeting room terminal 2 and the meeting device 3 to enable data communication with each other. The meeting room terminal 2 acquires, from the management server 1, information in the device information D2 (see FIG. 4) being the information necessary for connecting to the meeting device 3. For example, the management server 1 passes the information in the device information D2 to the meeting room terminal 2 only in the case of “License present”. Alternatively, in the case of “License present”, the meeting room terminal 2 may acquire, from the management server 1, an access right to the database DB, and may acquire the information in the device information D2 by directly accessing the database DB using the access right.

For example, if the display device 3A is installed in the meeting room R1, the meeting support application launches a voice control application, and passes, to the voice control application, information such as the IP address of the display device 3A of the meeting room R1, the port number, the device ID, and the authentication information included in the device information D2 acquired from the management server 1. As a result, it is possible for the user of the meeting room R1 to turn ON/OFF the power of the display device 3A by voice, or change the volume of the display device 3A by voice, for example.

For example, if the sharing device 3C is installed in the meeting room R1, the meeting support application launches a screen control application, and passes, to the screen control application, authentication information such as the IP address of the sharing device 3C of the meeting room R2, and the PIN number included in the device information D2 acquired from the management server 1. As a result, it becomes possible to share the display device 3B of the meeting room R2, and the display screens of the meeting room terminals 2B and 2C with each other.

Further, for example, the meeting support application launches an access control application for accessing the cloud storage, and passes, to the access control application, the access information (authentication information) for accessing the cloud storage acquired from the management server 1. This makes it possible to display the file (the display data) stored in the cloud storage, on the display screen of the meeting room terminal 2A of the meeting room R1. The cloud storage is a database (a data server) connected to the network N1, and is a database that is available in a cloud storage service, for example.

Further, for example, the meeting support application launches a meeting control application for setting the meeting system to change the setting value according to the meeting system. This allows the user to participate in a meeting utilizing the meeting system.

### Meeting Support Process

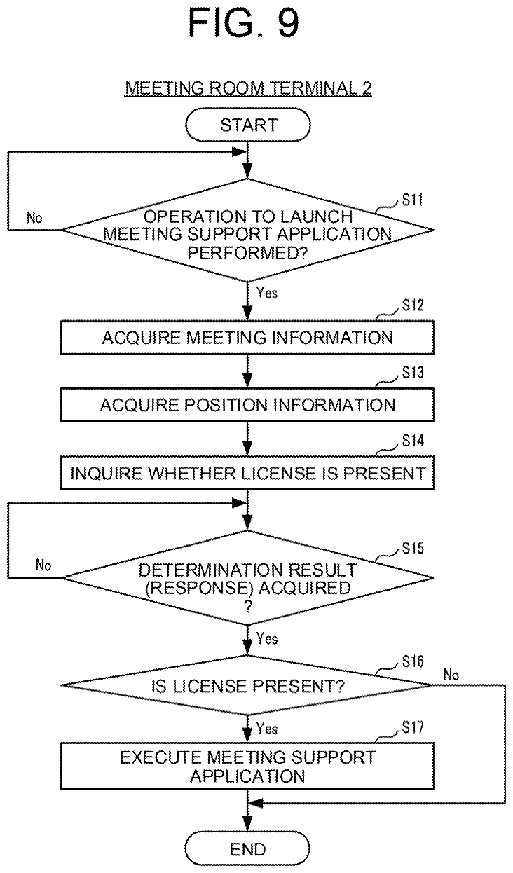

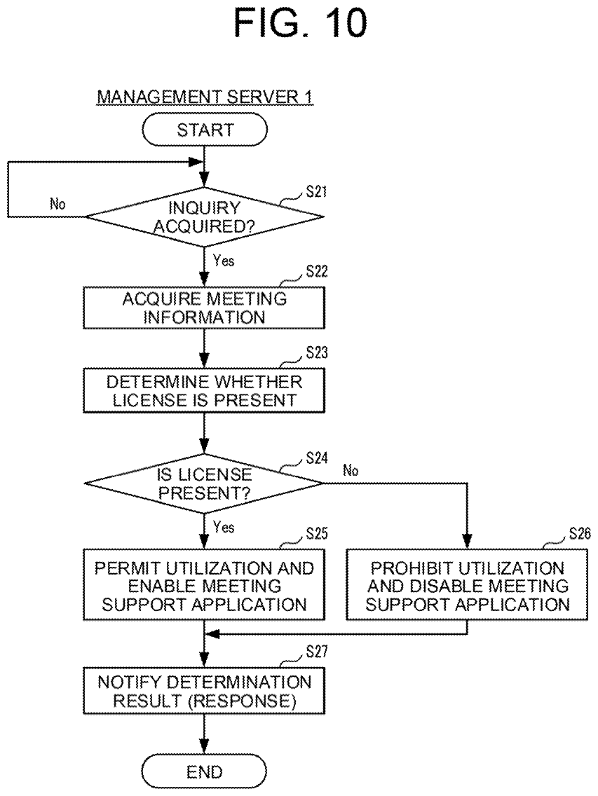

Next, an example of the procedure of the meeting support process executed in the meeting system 100 will be described with reference to FIGS. 9 and 10.

The present disclosure can be regarded as an invention of a meeting support processing method (an example of the information processing method of the present disclosure) in which one or more steps included in the meeting support process are executed. One or more steps included in the meeting support process described here may be omitted where appropriate. In addition, each of the steps in the meeting support process may be executed in a different order as long as a similar operation and effect is achieved. Although a case where each of the steps in the meeting support process is executed by each controller of the devices (the management server 1 and the meeting room terminal 2) included in the meeting system 100 will be described as an example here, in another embodiment, each of the steps in the meeting support process may be dispersedly executed by one or more processing devices.

Here, the meeting support process corresponding to the meeting M1 held in the meeting room R1 described above will be described as an example. FIG. 9 is a flowchart illustrating an example of the procedure of the meeting support process executed in the meeting room terminal 2A. For example, when the controller 21 of the meeting room terminal 2A accepts an operation of launching the meeting support application from the user A, the controller 21 starts the execution of the meeting support processing program to start the execution of the meeting support process. If a plurality of meeting room terminals 2 are included in a meeting room, for example, the meeting support process is individually executed in parallel in each meeting room terminal 2.

In step S11, the controller 21 of the meeting room terminal 2A receives an operation to launch the meeting support application. For example, the controller 21 receives a login operation from the user A. Specifically, the controller 21 acquires login information (user ID and password) entered by the user A on the login screen. Once the login information is acquired by the controller 21, the management server 1 performs the login process based on the login information.

Next, in step S12, the controller 21 acquires the meeting information from the database DB. Specifically, the controller 21 acquires, from the database DB, each information included in the meeting information D4 (see FIG. 6) of the meeting in which the user A identified by the login information of the user A participates.

Next, in step S13, the controller 21 acquires the position information of the meeting room terminal 2A. Step S13 may be omitted.

Next, in step S14, the controller 21 sends inquiry whether a license for the meeting support application is present to the management server 1. The inquiry includes meeting room information (the meeting room ID), user information (a participant ID, an email address, or the like), a meeting system type (system ID), the position information, and the like. Once the controller 21 sends the inquiry to the management server 1, the controller 11 of the management server 1 executes the meeting support process described later (see FIG. 10), based on the inquiry.

Next, in step S15, the controller 21 waits until a response to the inquiry is acquired from the management server 1.

Once the controller 21 acquires the response from the management server 1, the controller 21 determines whether the license for the meeting support application is “Present” or “Absent” in step S16.

If the license is “Present” (S16: Yes), the controller 21 executes the meeting support application in step S17. Note that, for example, while a first meeting support application is being executed, the meeting room terminal 2A may acquire the information in the device information D2 from the management server 1 and pass the information to a second meeting support application. In this case, the information passed to the second meeting support application may be utilized when the second meeting support application is executed. Step S17 is an example of an execution step according to the present disclosure.

If the license is “Absent” (S16: No), the controller 21 ends the processing without executing the meeting support application.

FIG. 10 is a flowchart illustrating an example of the procedure of the meeting support process executed in the management server 1. For example, the controller 11 of the management server 1 starts the execution of the meeting support process upon acquiring the inquiry from the meeting room terminal 2.

In step S21, the controller 11 waits until the inquiry is acquired from the meeting room terminal 2. Step S21 is an example of an inquiry acquisition process according to the present disclosure.

Once the controller 11 acquires the inquiry from the meeting room terminal 2, the controller 11 acquires the meeting information from the database DB in step S22. Specifically, the controller 11 acquires the meeting information corresponding to each information included in the inquiry with reference to the meeting information D4 (see FIG. 6) in the database DB.

In step S23, the controller 11 determines whether the license for the meeting support application is present, based on the acquired meeting information, and each information of the inquiry acquired from the meeting room terminal 2. For example, upon acquiring the inquiry from the meeting room terminal 2A, the controller 11 determines whether the license corresponding to the meeting room ID “R001” and the device ID “S001” of the display device 3A is present, with reference to the license information D5 (see FIG. 7). Here, a license for the meeting support application is granted to the display device 3A “S001” installed in the meeting room R1 where the meeting M1 is held, and therefore, the controller 11 determines that the license for the meeting support application in the display device 3A corresponding to the meeting room R1 is “Present”.

If the license is determined to be “Present” (S24: Yes), the processing proceeds to step S25, and if the license is determined to be “Absent” (S24: No), the processing proceeds to step S26.

In step S25, the controller 11 permits the meeting device 3 installed in the meeting room to utilize the meeting support application, and sets the meeting support application to enabled. For example, the controller 11 permits the display device 3A installed in the meeting room R1 to utilize the meeting support application, and sets the meeting support application to enabled. If the meeting support application is set to enabled, the management server 1 may pass the information in the device information D2 to the meeting room terminal 2 in response to a request from the meeting room terminal 2.

In step S26, the controller 11 prohibits the meeting device 3 installed in the meeting room from utilizing the meeting support application, and sets the meeting support application to disabled. For example, the controller 11 prohibits the voice processing device 3D installed in the meeting room R3 from utilizing the meeting support application, and sets the meeting support application to disabled. Steps S25 and S26 are examples of a utilization control process according to the present disclosure.

In step S26, the controller 11 notifies the meeting room terminal 2 of the determination result (response) regarding presence or absence of the license. For example, the controller 11 notifies the meeting room terminal 2A of a response (“License present”) indicating that the license for the meeting support application is present for the display device 3A. Also, for example, the controller 11 notifies the meeting room terminal 2D of a response (“License absent”) indicating that the license for the meeting support application is not present for the voice processing device 3D. Once the meeting room terminal 2 acquires the response from the management server 1, the meeting room terminal 2 executes the above-described processing (steps S15 to S17 in FIG. 9).

The meeting support process may include a registration processing for registering, in the database DB, the meeting room ID of a meeting room, the identification information of the meeting device 3 installed in the meeting room, and the license information on a license for the meeting support application corresponding to the meeting device 3, in a mutually associated manner. For example, the controller 11 of the management server 1 executes the registration processing. The registration processing is an example of a registration process according to the present disclosure.

As described above, the meeting system 100 executes the meeting support process. As described above, in the meeting system 100 according to the present embodiment, the identification information of the meeting room, the identification information of the meeting device 3 installed in the meeting room, and information on whether a license for the meeting support application corresponding to the meeting device 3 is present are registered in a mutually associated manner, for each meeting room. Further, in the meeting system 100, the utilization of the meeting support application in the meeting device 3 is controlled, based on the inquiry from the users participating in the meeting. Therefore, for example, if a meeting is held in a meeting room to which a license for the meeting support application is granted, it is possible for the users participating in the meeting to utilize the meeting support application in the meeting device 3 by logging in to the meeting. Therefore, it is necessary to perform the operation of switching the license for each meeting device 3 upon a start of the meeting. Thus, by managing the license for the meeting support application for each meeting room, it is possible to efficiently hold a meeting.

In the embodiment described above, the meeting system 100 corresponds to the information processing system according to the present disclosure, but the information processing system according to the present disclosure is not limited thereto. For example, the information processing system according to the present disclosure may be configured by the management server 1 alone, may be configured by the management server 1 and the meeting room terminal 2, or may be configured by the management server 1, the meeting room terminal 2, and the meeting device 3.

In the information processing system according to the present disclosure, within the scope of the invention described in claims, the embodiments described above may be freely combined, or the embodiments may be appropriately modified or some of the embodiments may be omitted.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An information processing system, comprising:
a registration processor that registers, in a storage, location information indicating a location where a meeting is held, identification information of a device installed at the location where the meeting is held, and license information regarding a license for a function corresponding to the device, in a mutually associated manner;
an inquiry acquirer that acquires an inquiry whether the license for the function is present; and
a utilization controller that controls a utilization of the function, based on the location information, the identification information of the device, and the license information stored in the storage, if the inquiry is acquired by the inquiry acquirer.

2. The information processing system according to claim 1, further comprising a license determiner that, if the inquiry is acquired by the inquiry acquirer, determines whether the license for the function is present, based on the location information, the identification information of the device, and the license information stored in the storage, wherein
if it is determined by the license determiner that the license for the function is present, the utilization controller permits utilization of the function.

3. The information processing system according to claim 2, wherein if the license for the function is granted to the device installed at the location where the meeting is held, the license determiner determines that the license for the function is present.

4. The information processing system according to claim 2, wherein the inquiry acquirer acquires position information of an operation terminal utilized by a participant of the meeting, and
if the license for the function is granted to the device installed at the location where the meeting is held, and if the position of the operation terminal is included in the location where the meeting is held, the license determiner determines that the license for the function is present.

5. The information processing system according to claim 2, wherein the registration processor further registers, in the storage, the location information and identification information of a participant of the meeting, in a mutually associated manner, and
if the license for the function is granted to the device installed at the location where the meeting is held, and if identification information of a user utilizing the device matches the identification information of the participant registered in the storage, the license determiner determines that the license for the function is present.

6. The information processing system according to claim 2, further comprising a notification processor, wherein
the inquiry acquirer acquires the inquiry from an operation terminal utilized by a participant of the meeting,
if the inquiry is acquired by the inquiry acquirer, the notification processor notifies the operation terminal of the determination result by the license determiner about whether the license is present.

7. The information processing system according to claim 2, further comprising an execution processor that executes the function, wherein
if it is determined by the license determiner that the license for the function is present, the execution processor connects an operation terminal utilized by a participant of the meeting to the device.

8. An information processing method comprising using one or more processing devices to execute:
registering, in a storage, location information indicating a location where a meeting is held, identification information of a device installed at the location where the meeting is held, and license information regarding a license for a function corresponding to the device, in a mutually associated manner;
acquiring an inquiry whether the license for the function is present; and
controlling a utilization of the function, based on the location information, the identification information of the device, and the license information stored in the storage, if the inquiry is acquired.

9. A non-transitory storage medium for storing an information processing program for causing one or more processing devices to execute:
registering, in a storage, location information indicating a location where a meeting is held, identification information of a device installed at the location where the meeting is held, and license information regarding a license for a function corresponding to the device, in a mutually associated manner;
acquiring an inquiry whether the license for the function is present; and
controlling a utilization of the function, based on the location information, the identification information of the device, and the license information stored in the storage, if the inquiry is acquired.
